(19) United States
(12) Patent Application Publication
(10) Pub. No.: US 2022/0134860 A1
(43) Pub. Date: May 5, 2022

(54) HYBRID AGRICULTURAL VEHICLE

(71) Applicant: CNH Industrial America LLC, New Holland, PA (US)

(72) Inventors: Harald Dannerbauer, St. Valentin (AT); Michael Zöttl, St. Peter (IT)

(73) Assignee: CNH Industrial America LLC, New Holland, PA (US)

(21) Appl. No.: 17/431,393

(22) PCT Filed: Feb. 14, 2020
(86) PCT No.: PCT/EP2020/053852

§ 371 Date: Aug. 16, 2021

(30) Foreign Application Priority Data
Feb. 14, 2019 (IT) 102019000002153

(51) Int. Cl. B60K 6/26; B60K 6/40; B60K 17/28; B60K 6/36; B60K 6/547

(52) U.S. Cl. CPC B60K 6/26; B60K 6/40; B60K 17/28; B60K 2023/0825; B60K 6/547; B60Y 2200/221; B60Y 2200/92; B60K 6/36

(57) ABSTRACT

A hybrid agricultural vehicle supplies electric power to a first electric motor, a second electric motor, and a third electric motor. The first electric motor provides torque to a first driveline that is designed to transfer received torque to driving wheels of the hybrid agricultural vehicle. The second electric motor provides torque to a second driveline that is designed to transfer received torque to a power take-off shaft of the hybrid agricultural vehicle. The third electric motor provides torque to a power distribution unit that is designed to provide the received torque to one or both of the first and second drivelines to provide extra torque to one or both of the driving wheels and the power take-off shaft.

### CROSS REFERENCE TO RELATED APPLICATIONS

This application is a U.S. National Stage filing of International Application Serial No. PCT/EP2020/053852 entitled “HYBRID AGRICULTURAL VEHICLE,” filed Feb. 14, 2020, which claims priority to Italian Application Serial No. 102019000002153, filed Feb. 14, 2019, each of which is incorporated by reference herein in its entirety for all purposes.

### TECHNICAL FIELD

The present invention concerns a hybrid agricultural vehicle.

### BACKGROUND OF THE INVENTION

Hybrid agricultural vehicles, for instance tractors, are provided with a source of electric power that may be used to supply one or more electric motor(s) that may be used alternatively or in conjunction with the internal combustion engine to move the vehicle and its implements.

For instance, polish patent application PL420593 describes an agricultural vehicle equipped with a combustion engine with a split hybrid traction drive of four wheels. The front axle is driven by two independent electric drive disc motors with each of which is placed in the hub of the front wheel and supplied from the accumulator battery via a voltage converter. The vehicle has a connection for charging the battery.

German patent application DE102010010863 describes a machine having an hybrid drive driving a working rotor for harvesting and/or cultivating crop. The drive comprises a mechanical drive train for driving the working rotor using a power take-off shaft. The drive comprises an electrical or fluid pressure-driven motor that is connectable with the working rotor over the drive train. The drive torque of the drive train is superimposed with the drive torque of the power take-off shaft.

Scope of the present invention is to provide a hybrid agricultural vehicle where a number of low-power electric motors may be used to provide torque to the wheels and to the power take off shaft in a very flexible way.

### SUMMARY OF THE INVENTION

The aforementioned aim is reached by the present invention as claimed in the appended set of claims.

### BRIEF DESCRIPTION OF DRAWINGS

For a better understanding of the present invention, a preferred embodiment is described in the following, by way of a non-limiting example, with reference to the attached drawings wherein:

FIG. 1 is a simplified schema of a hybrid agricultural vehicle realized according to the present invention; and

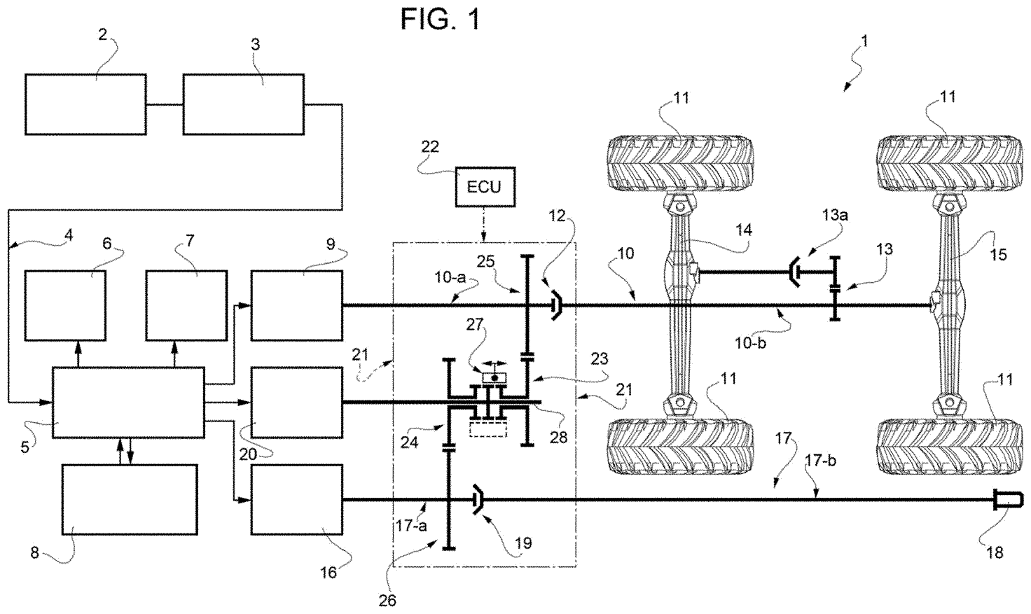

FIG. 2 shows different operating modes of the hybrid agricultural vehicle.

### DETAILED DESCRIPTION OF THE INVENTION

Numeral 1 indicates a hybrid agricultural vehicle, for instance a tractor, wherein an internal combustion engine 2, particularly a diesel engine, drives an electric generator 3 (of known kind and represented schematically) providing electric power 4 (electric power is schematized with an arrow, it is clear that suitable electric power lines are provided) to a power electronics 5 that is designed to supply electric drives of the vehicle 1. Preferably the engine 2 is a low power engine that is operated in a steady mode to minimize consumption and gas emissions.

In this case, the engine 2 and the electric generator 3 realize a source of electric power; it is however clear that other sources of electrical power may be used to supply power electronics 5, for instance batteries and supercapacitors (not shown) or power cell (not shown) or other alternative sources. The vehicle may also switch from one source of electric power (engine 2 and the electric generator 3 for instance) to another source (batteries or supercapacitors for instance).

More specifically, power electronics 5 provides electric power to internal electric devices 6 of the vehicle 1 (represented schematically, for instance the starter for engine cranking and/or the electric devices of the hydraulic power module, or of the air compressor and/or of the cooling system), to external electric devices 7 of the vehicle 1 (represented schematically, for instance electric devices installed on implements) and provides the charging of the batteries 8 of the vehicle 1.

According to the present invention power electronics 5 provides electric power to the electric drives. The electric drives comprise a first electric motor 9 controlled by the power electronics 5 and providing torque to a first driveline 10 that is designed to transfer received torque to the driving wheels 11 of the hybrid agricultural vehicle 1.

In the example, a clutch 12 is interposed along the driveline 10 that is divided in a first branch shaft 10-a that extends between the first electric motor 9 and the clutch 12 and a second branch shaft 10-b that extends between clutch 12 and a power transmission 13 connecting the front and rear axles 14,15 of the vehicle 1. The clutch 12 is in charge of connecting (coupling) or disconnecting (decoupling) the wheels 11. Further the front axle 14 may be connected or disconnected to/from the driveline 10 by means of a further clutch 13a. The clutch 12 is designed to engage and disengage power transmission or torque delivery from the first branch shaft 10-a to the second branch shaft 10-b.

Electric drives comprise a second electric motor 16 controlled by the power electronics 5 and providing torque to a second driveline 17 that is designed to transfer received torque to the power take-off (PTO) shaft 18 of the hybrid agricultural vehicle 1.

A power take-off or power takeoff (PTO) is any of several methods for taking power from a power source, such as a running engine or an electric motor, and transmitting it to an application such as an attached implement or separate machines.

In the example, a clutch 19 is interposed along the second driveline 17 that is divided in a first branch shaft 17-a that extends between the second electric motor 16 and the clutch 19 and a second branch shaft 17-b that extends between clutch 19 and the PTO shaft 18. The clutch 19 is designed to engage and disengage power transmission or torque transfer from the first branch shaft 17-a to the second branch shaft 17-b. Thus, clutch 19 allows the coupling or decoupling of the PTO shaft 18 from the first branch shaft 17-a

Finally, a third electric motor 20 is provided and controlled by the power electronics 5 and it provides torque to a power distribution unit 21 that is designed to deliver the received torque to one or both the first 10 and second driveline 17 to provide extra torque to the driving wheels 11 and/or to the PTO shaft 18. Power distribution unit is also designed to permit torque transfer between first drive line 10 and the second driveline 17.

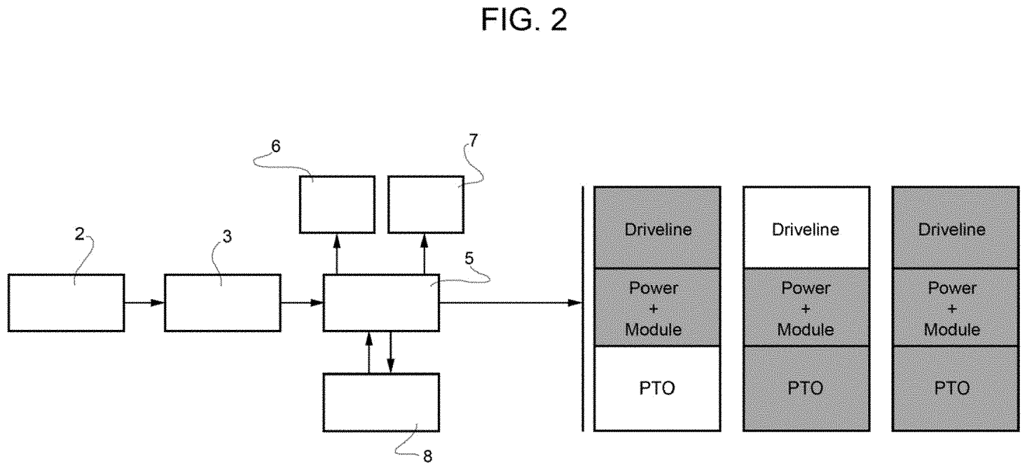

An electronic control unit 22 is provided to control the power distribution unit 21 in order to provide different operating modes (see FIG. 2):

A first operating mode, called a driveline power mode wherein the power distribution unit 21 provides the torque of the third motor 20 to the first driveline 10 where the torques generated by the first motor 9 and the third motor 20 combine to enhance the power delivered to the driveline 10. In addition, the torque provided by the second motor 16 is also supplied to the first driveline 10 through the power distribution unit 21 so that also the torque generated by the first motor 9 and the torque generated by the second motor 16 combine to enhance power delivered to the driveline 10. In this mode, all motors 9, 20 and 16 provide torque to the driveline 10. Clutch 19 is opened and the PTO 18 is not powered. Clutch 12 when closed permits torque transfer to the wheels 11. This mode is quite useful when extra traction power is needed for instance during ploughing or transport of heavy trailers.

A second operating mode, called a dynamic PTO power mode wherein the power distribution unit 21 provides the torque of the third motor 20 to the second driveline 17 where the torques generated by the second motor 16 and the third motor 20 combine to enhance the power delivered to the PTO shaft. This mode is quite useful during special operation such as power harrowing and bailing. During this mode, the torque generated by the first motor 9 is provided to the first driveline 10 (the clutch 12 is closed) so that the vehicle 1 may move thanks to the torque provided to the wheels 11. Power distribution unit 21 is in a position where the transfer of torque from driveline 10 to driveline 17 is not permitted;

A third operating mode, called a stationary PTO power mode, wherein the power distribution unit 21 provides the torque of the first motor 9 to the second driveline 17 through power distribution unit 21 where the torque generated by first motor 9 combines with the torque generated by the second motor 16. Power distribution unit 21 is in a position where the transfer of torque from driveline 10 to driveline 17 is permitted. The torque of the third motor 20 is also supplied to the second driveline 17 where the torque generated by the third motor 20 combines with the torque generated by the second motor 16. In this mode, all motors 9, 20 and 16 provide torque to the PTO shaft 18 (clutch 19 is closed).

This mode is quite useful during special operation such as wood chipping. During this mode clutch 12 is opened and torque transmission to the wheel is prevented, vehicle 1 cannot move. In the example, the power distribution unit 21 is schematized by means of a first gear 23 and a second gear 24 having the same radius R1, it is possible also to have the first gear 23 and a second gear 24 designed with different radius with respect each other. Gears 23,24 are coupled with respective third and fourth gears 25, 26 (with the same radius R2) carried respectively by the first branch shaft 10-a and 17-a. It is however possible also to have the third gear 25 and a fourth gear 26 designed with different radius with respect each other.

Gear 23, 24, are designed to be carried in a rotatably free manner, e.g. via known bushings, by the output shaft 28. Gear 25, is designed to be carried in a rotatably locked manner by the first branch shaft 10-a, namely it is firmly connected to the shaft 10-a. Similarly, gear 26, is designed to be carried in a rotatably locked manner by the second branch shaft 17-a, namely it is firmly connected to the shaft 17-a. A selecting device 27, for example a dog clutch, moved by an actuator (not shown) and controlled by the electronic control unit 22 provides the connection of the first gear 23, the second gear 24 or both the gears 23 and 24 with the output shaft 28 When the selecting device 27 is in the neutral position (it is not engaging the gears 23 or 24), the rotational speeds of the output shaft 28 and the first gear 23 or second gear 24 are different.

On the contrary, when the selecting device 27 is commanded by electronic control unit 22 to firmly engaging one or both the first and second gears 23, 24 with the shaft 28, the output shaft 28 and the gear 23, 24 that has been selected rotate at the same rotational speed. Thus, the third electric motor 20 by rotating the output shaft 28 may transmit the torque to the first branch shaft 10-a (selecting device 27 in this case connects the gear 23 to the output shaft 28), or to the second branch shaft 17-a (selecting device 27 in this case connects the gear 24 to the output shaft 28) or to both branch shafts 10-a and 17-a (selecting device 27 in this case connects the gear 23 and the gear 24 to the output shaft 28). Electronic control unit (ECU) 22 also controls the speed of motors 9, 20 and 16 according to known techniques so that the speed of gears 25, 23 and 24, 26 can also be controlled, and through the selecting device 27, the power distribution unit 21 and the ECU 22 allow a control of the torque delivered to the drivelines 10 and 17.

The torque delivered from the electric motors 9,20,16 to other elements may incur in torque losses when the torque is transferred. In the present invention, the transfer of torque shall include also any eventual losses incurred during the transfer. For example, the connection between gears 23 with gear 25 and the connection between gear 24 and gear 26 may cause some torque losses during the torque transfer (therefore by means of the power distribution unit 21) from electric motor 16 to the driveline 10.

In view of the foregoing, the advantages of the hybrid agricultural vehicle according to the invention are apparent. The agricultural vehicle is quite flexible in using alternative power supplies (diesel and E-generator can be switched to other electric energy sources because there is no mechanical connection from the internal combustion engine 2 to the drivelines 10 and 17).

Small electric motors 9, 20 and 16 could be used (cost-effective due to high volume production).

Easy and cost-effective design of the gearbox (power distribution unit 21), no wet clutches necessary due to electrical speed adjustment before gearshift.

Smart driveline software (driving strategies) can secure the e-motor to always be driven in high efficiencies.

Stepless PTO and driveline engagement/startup from 0 to maximum speed.

1-11. (canceled)

12. A hybrid agricultural vehicle, comprising:
an electronic control unit;
a first electric motor configured to generate a first torque;
a first driveline configured to receive the first torque and transfer the received first torque to driving wheels of the vehicle;
a second electric motor configured to generate a second torque;
a second driveline configured to receive the second torque and transfer the received second torque to a power take-off shaft of the vehicle; and
a third electric motor configured to generate a third torque;
a power distribution unit configured to receive the third torque and to provide the received third torque to at least one of the first driveline for transfer to the driving wheels and the second driveline for transfer to the power take-off shaft.

13. The hybrid agricultural vehicle as claimed in claim 12, wherein the power distribution unit comprises:
an output shaft carrying a first and a second gear;
a first branch shaft carrying a third gear coupled to the first gear; and
a second branch shaft carrying a fourth gear coupled to the second gear.

14. The hybrid agricultural vehicle as claimed in claim 13, wherein the first and the second gear are carried by the output shaft in a rotatably free manner.

15. The hybrid agricultural vehicle as claimed in claim 14, wherein the third gear is attached to the first branch shaft and the fourth gear is attached to the second branch shaft.

16. The hybrid agricultural vehicle as claimed in claim 13, wherein the power distribution unit further comprises a selecting device controlled by the electronic control unit and configured to selectively engage at last one of the first gear and the second gears to the output shaft such that the output shaft and the engaged at least one of the first gear and the second gear rotates at the same rotational speed.

17. The hybrid agricultural vehicle as claimed in claim 13, wherein the first driveline comprises a clutch configured to connect or disconnect the first branch shaft to or from the driving wheels.

18. The hybrid agricultural vehicle as claimed in claim 13, wherein the second driveline comprises a clutch configured to connect or disconnect the second branch shaft to or from the power take-off shaft.

19. The hybrid agricultural vehicle as claimed in claim 12, wherein the power distribution unit is configured to permit selective a bi-directional torque transfer from the second electric motor to the first driveline.

20. The hybrid agricultural vehicle as claimed in claim 19, wherein the electronic control unit is configured to control the power distribution unit according to provide a first operating mode in which the first driveline receives torque from each of the first electric motor, the second electric motor, and the power distribution unit as a combined torque that is transferred to the driving wheels.

21. The hybrid agricultural vehicle as claimed in claim 19, wherein the electronic control unit is configured to control the power distribution unit according to a second operating mode in which:
the second driveline receives the third torque from the power distribution unit such that the second and third torques generated by the second motor and the third motor, respectively, combine to enhance the torque received by the power take-off shaft, and
only the first driveline receives the first torque generated by the first motor.

22. The hybrid agricultural vehicle as claimed in claim 12, wherein the power distribution unit is also configured to permit a torque transfer from the first electric motors to the second driveline.

23. The hybrid agricultural vehicle as claimed in claim 22, wherein the electronic control unit is further configured to control the power distribution unit according to a third different operating mode in which the second driveline receives torque from each of the first electric motor, the second electric motor, and the power distribution unit as a combined torque that is transferred to the power take-off shaft.

24. The hybrid agricultural vehicle as claimed in claim 12, further comprising an internal combustion engine configured to provide a source of electric power that drives an electric generator providing electric power to a power electronic, the power electronic being configured to supply the electric power to the first, second, and third electronic motors.
